(19) United States
(12) Patent Application Publication
(10) Pub. No.: US 2024/0214132 A1
(43) Pub. Date: Jun. 27, 2024

(54) Alternative HARQ Configuration for XR Uplink Data Transmission

(71) Applicant: Nokia Technologies Oy, Espoo (FI)

(72) Inventors: Abolfazl Amiri, Aalborg (DK); Klaus Ingermann PEDERSEN, Aalborg (DK); Zexian LI, Espoo (FI); Stefano PARIS, Vanves (FR)

(21) Appl. No.: 18/545,332

(22) Filed: Dec. 19, 2023

Related U.S. Application Data
(60) Provisional application No. 63/434,958, filed on Dec. 23, 2022.

(51) Int. Cl. H04L 1/1829

(52) U.S. Cl. CPC H04L 1/1854

(57) ABSTRACT

An apparatus configured to: transmit, to a UE, signaling for scheduling retransmission of at least one transport block of a bundle of uplink transmissions, including at least one of: an indication of at least one resource for the retransmission, an indication of whether a duplicate of the at least one transport block, or a redundant version of the at least one transport block is to be retransmitted, an indication of a MCS for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block.

### TECHNICAL FIELD

The example and non-limiting embodiments relate generally to retransmission of data packets and, more particularly, to selective retransmission of data packets.

### BACKGROUND

It is known, in network communication, to enable repeated transmission of transmit time intervals.

### SUMMARY

The following summary is merely intended to be illustrative. The summary is not intended to limit the scope of the claims.

In accordance with one aspect, an apparatus comprising: at least one processor; and at least one memory storing instructions that, when executed by the at least one processor, cause the apparatus at least to: transmit, to a user equipment, signaling for scheduling retransmission of at least one transport block of a bundle of uplink transmissions, wherein the signaling for scheduling the retransmission of the at least one transport block comprises at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and receive, from the user equipment, the retransmission of the at least one transport block.

In accordance with one aspect, a method comprising: transmitting, to a user equipment, signaling for scheduling retransmission of at least one transport block of a bundle of uplink transmissions, wherein the signaling for scheduling the retransmission of the at least one transport block comprises at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and receiving, from the user equipment, the retransmission of the at least one transport block.

In accordance with one aspect, an apparatus comprising means for performing: transmitting, to a user equipment, signaling for scheduling retransmission of at least one transport block of a bundle of uplink transmissions, wherein the signaling for scheduling the retransmission of the at least one transport block comprises at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and receiving, from the user equipment, the retransmission of the at least one transport block.

In accordance with one aspect, a non-transitory computer-readable medium comprising program instructions stored thereon for performing at least the following: causing transmitting, to a user equipment, of signaling for scheduling retransmission of at least one transport block of a bundle of uplink transmissions, wherein the signaling for scheduling the retransmission of the at least one transport block comprises at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and causing receiving, from the user equipment, of the retransmission of the at least one transport block.

In accordance with one aspect, an apparatus comprising: at least one processor; and at least one memory storing instructions that, when executed by the at least one processor, cause the apparatus at least to: receive signaling for scheduling retransmission of at least one transport block of a bundle of uplink transmissions, wherein the signaling for scheduling the retransmission of the at least one transport block comprises at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and perform uplink transmission based, at least partially, on the signaling for scheduling the retransmission of the at least one transport block.

In accordance with one aspect, a method comprising: receiving, with a user equipment, signaling for scheduling retransmission of at least one transport block of a bundle of uplink transmissions, wherein the signaling for scheduling the retransmission of the at least one transport block comprises at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and performing uplink transmission, with the user equipment, based, at least partially, on the signaling for scheduling the retransmission of the at least one transport block.

In accordance with one aspect, an apparatus comprising means for performing: receiving signaling for scheduling retransmission of at least one transport block of a bundle of uplink transmissions, wherein the signaling for scheduling the retransmission of the at least one transport block comprises at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and uplink transmission based, at least partially, on the signaling for scheduling the retransmission of the at least one transport block.

In accordance with one aspect, a non-transitory computer-readable medium comprising program instructions stored thereon for performing at least the following: causing receiving of signaling for scheduling retransmission of at least one transport block of a bundle of uplink transmissions, wherein the signaling for scheduling the retransmission of the at least one transport block comprises at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and causing performing of uplink transmission based, at least partially, on the signaling for scheduling the retransmission of the at least one transport block.

In accordance with one aspect, an apparatus comprising: at least one processor; and at least one memory storing instructions that, when executed by the at least one processor, cause the apparatus at least to: determine that a number of transport blocks have been lost; and transmit, to a user equipment, signaling for scheduling retransmission of at least one transport block of the transport blocks that have been lost in response to determining that the number of transport blocks have been lost.

In accordance with one aspect, a method comprising: determining that a number of transport blocks have been lost; and transmitting, to a user equipment, signaling for scheduling retransmission of at least one transport block of the transport blocks that have been lost in response to determining that the number of transport blocks have been lost.

In accordance with one aspect, an apparatus comprising means for performing: determining that a number of transport blocks have been lost; and transmitting, to a user equipment, signaling for scheduling retransmission of at least one transport block of the transport blocks that have been lost in response to determining that the number of transport blocks have been lost.

In accordance with one aspect, a non-transitory computer-readable medium comprising program instructions stored thereon for performing at least the following: determining that a number of transport blocks have been lost; and causing transmitting, to a user equipment, of signaling for scheduling retransmission of at least one transport block of the transport blocks that have been lost in response to determining that the number of transport blocks have been lost.

In accordance with one aspect, an apparatus comprising: at least one processor; and at least one memory storing instructions that, when executed by the at least one processor, cause the apparatus at least to: receive signaling for scheduling transmission of one or more transport blocks; initiate transmission of the one or more transport blocks based, at least partially, on the signaling for scheduling the transmission of the one or more transport blocks; receive signaling for scheduling retransmission of at least one transport block of the one or more transport blocks; and perform retransmission of the at least one transport block based, at least partially, on the signaling for scheduling the retransmission of the at least one transport block.

In accordance with one aspect, a method comprising: receiving, with a user equipment, signaling for scheduling transmission of one or more transport blocks; initiating transmission of the one or more transport blocks based, at least partially, on the signaling for scheduling the transmission of the one or more transport blocks; receiving signaling for scheduling retransmission of at least one transport block of the one or more transport blocks; and performing retransmission of the at least one transport block based, at least partially, on the signaling for scheduling the retransmission of the at least one transport block.

In accordance with one aspect, an apparatus comprising means for performing: receiving signaling for scheduling transmission of one or more transport blocks; initiating transmission of the one or more transport blocks based, at least partially, on the signaling for scheduling the transmission of the one or more transport blocks; receiving signaling for scheduling retransmission of at least one transport block of the one or more transport blocks; and retransmission of the at least one transport block based, at least partially, on the signaling for scheduling the retransmission of the at least one transport block.

In accordance with one aspect, a non-transitory computer-readable medium comprising program instructions stored thereon for performing at least the following: causing receiving of signaling for scheduling transmission of one or more transport blocks; initiating transmission of the one or more transport blocks based, at least partially, on the signaling for scheduling the transmission of the one or more transport blocks; causing receiving of signaling for scheduling retransmission of at least one transport block of the one or more transport blocks; and causing performing of retransmission of the at least one transport block based, at least partially, on the signaling for scheduling the retransmission of the at least one transport block.

According to some aspects, there is provided the subject matter of the independent claims. Some further aspects are defined in the dependent claims.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a diagram illustrating features as described herein;

FIG. 3 is a diagram illustrating features as described herein;

FIG. 4 is a diagram illustrating features as described herein;

FIG. 5 is a diagram illustrating features as described herein;

FIG. 6 is a flowchart illustrating steps as described herein;

FIG. 7 is a flowchart illustrating steps as described herein;

FIG. 8 is a flowchart illustrating steps as described herein;

FIG. 9 is a flowchart illustrating steps as described herein; and

FIG. 10 is a flowchart illustrating steps as described herein.

### DETAILED DESCRIPTION OF EMBODIMENTS

The following abbreviations that may be found in the specification and/or the drawing figures are defined as follows:
3GPP third generation partnership project
5G fifth generation
5GC 5G core network
6G sixth generation
AMF access and mobility management function
AR augmented reality
BLER block error rate
BSR buffer status report
CE control element
CG configured grant
cRAN cloud radio access network
CU central unit
DCI downlink control information
DG dynamic grant
DL downlink
DU distributed unit
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
FDD frequency division duplex
gNB (or gNodeB) base station for 5G/NR, i.e., a node providing NR user plane and control plane protocol terminations towards the UE, and connected via the NG interface to the 5GC
HARQ hybrid automatic repeat request
I/F interface
L1 layer 1
LTE long term evolution
MAC medium access control
MCS modulation and coding scheme
MME mobility management entity
MR mixed reality
ng or NG new generation
ng-eNB or NG-eNB new generation eNB
NR new radio
NTN non-terrestrial networks
N/W or NW network
O-RAN open radio access network
PDB packet delay budget
PDCP packet data convergence protocol
PDSCH physical downlink shared channel
PHY physical layer
PRB physical resource block
PUSCH physical uplink shared channel
QoS quality of service
RAN radio access network
RE resource element
ReTX or reTX retransmission
RF radio frequency
RLC radio link control
RRC radio resource control
RRH remote radio head
RS reference signal
RU radio unit
Rx receiver
SCS subcarrier spacing
SDAP service data adaptation protocol
SGW serving gateway
SI system information
SMF session management function
TB transport block
TDD time division duplex
TTI transmit time interval
Tx transmitter
UCI uplink control information
UE user equipment (e.g., a wireless, typically mobile device)
UL uplink
UPF user plane function
VNR virtualized network function
VR virtual reality
XR extended reality (e.g. AR, MR, VR, etc.)

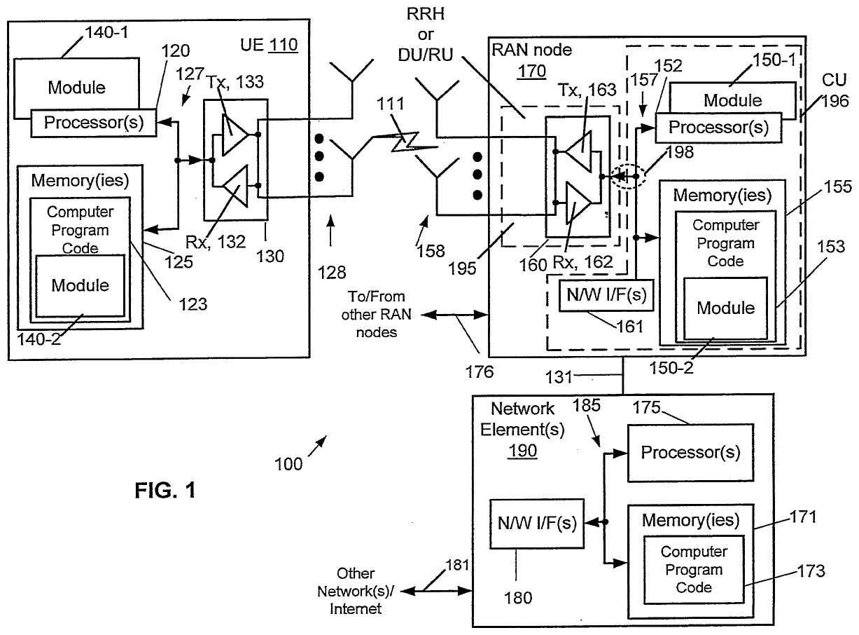

Turning to FIG. 1, this figure shows a block diagram of one possible and non-limiting example in which the examples may be practiced. A user equipment (UE) 110, radio access network (RAN) node 170, and network element (s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. A “circuit” may include dedicated hardware or hardware in association with software executable thereon. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR), and/or 5G-Advanced (i.e. NR Rel-18 and beyond) and/or 6G. In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element (s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit (s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station, access point, access node, or node.

The RAN node 170 includes one or more processors 152, one or more memories 155, one or more network interfaces (N/W I/F (s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor (s) 152, memories 155, and network interfaces 161. Note that the DU 195 may also contain its own memory/memories and processor (s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely illustrative functions that may be supported by the network element (s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. For example, a network may be deployed in a tele cloud, with virtualized network functions (VNF) running on, for example, data center servers. For example, network core functions and/or radio access network (s) (e.g. CloudRAN, O-RAN, edge cloud) may be virtualized. Note that the virtualized entities that result from the network virtualization are still implemented, at some level, using hardware such as processors 152 or 175 and memories 155 and 171, and also such virtualized entities create technical effects.

It may also be noted that operations of example embodiments of the present disclosure may be carried out by a plurality of cooperating devices (e.g. cRAN).

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various example embodiments of the user equipment 110 can include, but are not limited to, cellular telephones such as smart phones, tablets, personal digital assistants (PDAS) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Having thus introduced one suitable but non-limiting technical context for the practice of the example embodiments of the present disclosure, example embodiments will now be described with greater specificity.

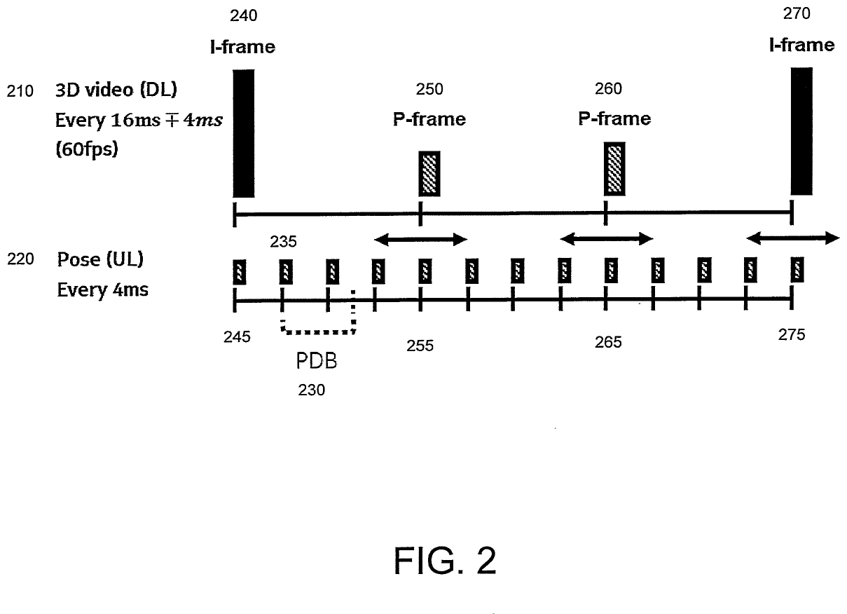

Features as described herein generally relate to retransmission of lost packets and/or repetition transmission for selected packets. For example, packets may contain pose and/or haptic data. Referring now to FIG. 2, illustrated is an example of uplink (UL) extended reality (XR) traffic. According to the agreed UL XR traffic model in 3GPP Rel-17, pose and haptic data is sent every 4-5 ms (220). The packet delay budget (PDB) for these type of traffic is 10 ms. Downlink (DL) traffic, such as 3D video, may be transmitted every 16.67 ms (210) (for the case of 60 frames per second video).

With time division duplex (TDD) frame structure “DDDSU” (in which D is downlink, U is uplink, and S is special slot), the UL delay budget (230) could further be reduced to 5 ms (1 out of 10 subframes), since the packet most likely spends some time sitting in the UE buffer before transmission. Reliability targets are in the range of 99.9-99.999%. All pose updates are in the same quality of service (QOS) flow with the same importance when they are being generated. However, depending on their relative timing to the incoming DL video frame (e.g. 240, 250, 260, 270), some become less important. Therefore, not all pose updates have the same importance. The typical UL pose update rate should be the same as the minimum DL frame rate; additional transmission may be used for prediction and/or correction purposes. With 60 fps in DL (210) and 250 pose/second in UL (220), only 1 out of 4 pose updates are relevant/required for the application (e.g. 245, 255, 265, 275). Other pose updates, such as 235, may become irrelevant based on the expiration of the PDB (230). The importance of a pose update may be derived from the relative timing of the pose update as compared to a most recent DL XR frame (e.g. TDD frame structure limitation(s)).

Example embodiments of the present disclosure are not limited to packets including pose and/or haptic data; other data may be transmitted via packets, for example XR data/traffic (e.g. video data, audio data, control data) or non-XR data/traffic. For example, periodic or quasi-periodic data/updates/traffic may be transmitted via packets according to example embodiments of the present disclosure. Such periodic data may be valid/useful/wanted for only a limited time. In the present disclosure, the phrases “pose data,” “pose update,” “pose packet,” “pose ReTX,” “update,” “ReTX instance,” and “retransmission packet” may be used interchangeably. Furthermore, such information items may additionally or alternatively carry other data/information, including but not limited to haptic data and/or other XR data.

XR relates to a variety of immersive technologies, including but not limited to virtual reality (VR), augmented reality (AR), and mixed reality (MR). Virtual reality (VR) is an area of technology in which video content may be provided (e.g. streamed) to, for example, a VR display system. VR video content may be provided alongside other VR content, such as audio, haptic, etc. content. The VR display system may be provided with a live or stored feed from a video content source, the feed representing a VR space or world for immersive output through the display system. A virtual space or virtual world is any computer-generated version of a space, for example a captured real-world space, in which a user can be immersed through a display system such as a VR headset. A VR headset may be configured to provide VR video and audio content to the user, e.g. through the use of a pair of video screens and headphones incorporated within, or associated with, the headset. A VR headset may be configured to provide feedback, for example pose/haptic data, to a server for purposes of informing the provision of VR content. Augmented reality (AR) and mixed reality (MR) may be similar to VR in that video content may be provided, as above, which may be overlaid over or combined with aspects of a real-world environment in which the AR/MR content is being consumed. A user of AR content may therefore experience a version of the real-world environment that is “augmented” with additional virtual features, such as virtual visual and/or audio objects. A device may provide AR video and audio content overlaid over a visible, see-through, or recorded version of the real-world visual and audio elements.

In an example scenario, if any of the pose/haptic packets transmitted by a UE is lost, the hybrid automatic repeat request (HARQ) process may try to recover it. The gNB may schedule another UL grant for retransmission. The gNB may send a downlink control information (DCI) to notify the UE of this retransmission. One potential issue may be that the retransmission (ReTx) instances are likely to be beyond the PDB, and thus the “lost” data is useless, as a new pose/haptic packet would be in transmission/transmitted by then. Even if the gNB knows how much of the PDB is left for each of the pose packets, it may still need to send a scheduling DCI in the next available DL slot and schedule the UE for ReTX of packets beyond the PDB. Moreover, the UE may always need to listen to DCIs for pose ReTX; this may lead to additional/unnecessary power consumption.

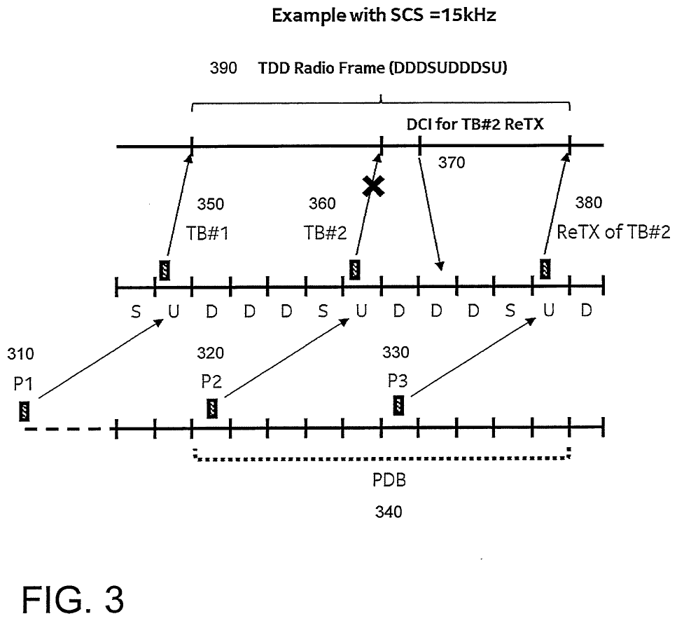

A simple illustration of this scenario is presented in FIG. 3, where for the sake of illustration we assume 5 ms as periodicity of pose updates, which are indicated as Pi with i=1,2,3 . . . (e.g. 310, 320, 330). Pose packet P1 (310) may be transmitted via transport block #1 (350) during the TDD Radio Frame structure (DDDSUDDDSU) (390). Transmission in ‘U’ slots of the radio frame structure may need to meet a requirement of ultra-reliable (i.e. retransmission may not be possible). The first transmission attempt of Transport Block (TB) #2 (360), which carries pose packet P2 (320), fails and is scheduled for retransmission, for example via DCI (370). As shown in FIG. 3, for a scenario with subcarrier spacing (SCS) of 15 KHz and PDB (340) of 10 ms, the retransmission of TB #2 (360) is done/scheduled when the PDB (340) is expired and a new pose information P3 (330) has been generated, thus invalidating the previous pose P2 (320). In other words, by the time retransmission of TB #2 (360) is scheduled, it may no longer be useful to actually retransmit TB #2 (360).

One trivial solution to avoid retransmission of late packets is to disable HARQ retransmissions, as used in non-terrestrial networks (NTN). This idea is interesting for NTN, where the round trip time is higher compared to terrestrial networks and retransmission could be way beyond the delay budget (see, e.g., 3GPP TS 38.821). A similar solution was also mentioned in [R2-2212333], where it is proposed to disable the UL retransmissions for pose data for both dynamic grant (DG) and configured grant (CG). The solution may also be extended to adapt the number of maximum retransmissions, as to indicate at each UL pose retransmission if it is the last re-transmission, or if the current transmission will have no retransmissions.

However, deactivation of retransmission can cause other problems, such as failure to guarantee a certain block error rate (BLER) that is required for pose/haptic or similar services, or requiring much more conservative modulation and coding scheme (MCS) selection (e.g. leading to reduced spectral efficiency). Furthermore, disabling HARQ retransmission results in loss of the benefits it was designed to provide. Specifically, lost TBs cannot be recovered (i.e. for XR applications, pose updates with frequency matching video framerate are needed) and link adaptation schemes, which use losses as indication of selecting more reliable modulation and coding schemes, would not work properly.

Another approach for increasing the reliability of the first transmission of pose packets and prevent late HARQ retransmissions is the use of transmit time interval (TTI) bundling, which was defined in TS 36.321 and TS 36. When TTI bundling is enabled, a UE performs initial transmission and retransmissions in four consecutive TTIs with different error detection and correction bits. In other words, a gNB may schedule a UE to repeat transmission of a same TTI multiple times. Similarly, in 5G NR, both slot based Type-A physical uplink shared channel (PUSCH) repetition and non-slot based Type-B PUSCH repetition are supported from Rel-16 onwards. We observe that this feature cannot be used for all numerologies and TDD frame structures. In particular, in Rel-17 and Rel-18 3GPP XR SIs on XR evaluation and enhancements, numerology 1 was used (SCS=30 kHz) and mini-slot was not considered for typical deployments executing XR applications.

TTI bundling does not solve the issue of transmission loss for UL pose information in TDD FR1 deployments. Instead, for those deployments that can support multiple consecutive UL TTI within the tight XR PDB, like FR2 deployments with SCS=120 kHz, TTI bundling suffers from high overhead due to the blind repetition of all pose updates.

As illustrated in FIG. 2, new pose updates may invalidate previous pose transmissions. In the example of FIG. 3, pose P3 (330) invalidates P2 (320). However, the use of TTI bundling may cause excessive overhead, since all pose updates must be duplicated four times, provided that the numerology and TDD frame structure support four consecutive TTIs. If we consider a periodicity of 4 ms for pose updates and TDD frame structure “DDDSU,” as indicated in the 3GPP XR SI, then one ‘U’ slot every 10 ms may be dedicated to the transmission of two pose packets, thus making the excess overhead problem even worse, since a slot will need to support eight transmissions (i.e. four per pose). It may be noted that, in FIG. 3, multiple TTI in ‘U’ slot may be available, but the pose update frequency may make the use of TTI bundling in TDD less effective.

In an example embodiment, selective retransmission of lost packets may be enabled. For example, packets from the same QoS flow may be retransmitted. A technical effect of example embodiments of the present disclosure may be to prevent transmission of expired PDB packets. A technical effect of example embodiments of the present disclosure may be to use HARQ retransmission to provide reliability for a subset of important (pose) packets. A technical effect of example embodiments of the present disclosure may be to address retransmission of late UL packets without violating PDB and reliability requirements.

In an example embodiment, a retransmission configuration may be implemented and/or provided from a network to a UE. In an example embodiment, the TB (s) to be repeated may be known beforehand. In an example embodiment, transmission may be repeated over multiple time-frequency resources. In an example embodiment, additional resources may be reserved for only a subset of UL transmissions. The subset of UL transmissions may take the form of M consecutive TBs, after which additional resources may be pre-allocated. The additional resources may take the form of time-frequency resources that may be used by the network to increase the transmission reliability. For example, for every M-th PUSCH, there may be an additional resource pre-scheduled (e.g. separately configured grant (CG) PUSCH resource or scheduled with a retransmission configuration, for example a dynamic grant (DG) PUSCH resource) for repetition, or more resources in the frequency domain may be pre-scheduled for the transmitting the TB using a highly reliable MCS. The DG may be signaled via DCI.

The network may pre-configure which UL TB (s) will be repeated, and may also signal if the repetition should exactly duplicate the transport block. A same or different modulation and coding scheme (MCS), a same or different transmission format (i.e. encoding and number of r PHY resources) may be used (e.g. incremental redundancy where encoding and number of PHY resources for ReTX differs slightly from first TX). In an example embodiment, the network may send information about how original transmission and/or repetition may be performed.

The network may take into account the frame/slot/sub-slot structure when configuring the rules. For example, in case some UL pose information generated during DL slot/symbols results in a longer buffering delay, in the next ‘U’ slot of the TDD frame structure, the UE may be automatically allocated with more resources for robust transmission. Here, it may be assumed that the network knows the traffic periodicity, which is a reasonable assumption for quasi-periodic traffic like UL XR traffic. In all use cases where CG or periodic buffer status report (BSR) plus DG are configured, as in both cases (CG or BSR+DG), the network may be required to configure the periodicity of the scheme for TB repetition according to the traffic period. If additional assistance information about the relative importance of packets is known, then the network may optimize the resource utilization by minimizing the repetitions configured via a retransmission configuration. For example, the knowledge that only one out of M packets (or bursts or PDU sets) is important, while the remaining M−1 are derived, may be used by the network to reserve additional resources (i.e., retransmission/repetition via/based on a retransmission configuration, or allocation of more physical resource blocks (PRBs) for the repetition) only for one out of M consecutive UL packet transmissions. A technical effect of more robust (conservative) transmission may be an increased probability of a successful TB transmission.

When configuring resource (s) for retransmission/repeated transmission, the network may consider at least one of: a traffic periodicity the user equipment is using for initial transmission of one or more transport blocks, a bundle size of the bundle of uplink transmissions, and/or a respective priority/importance level of the at least one transport block. For example, the network may determine to allocate resources for repetition/retransmission of a transport block with a higher priority level, and may determine to not allocate resources for repetition/retransmission of a transport block with a lower priority level, for example if network congestion is high.

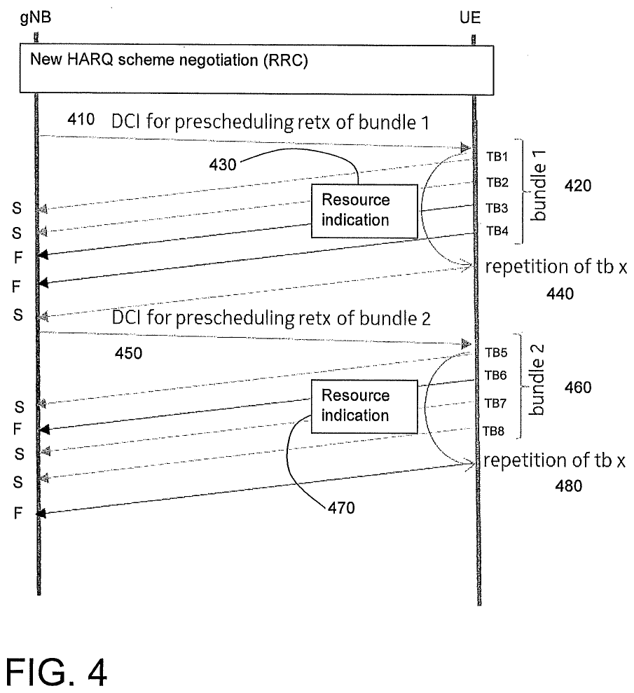

Referring now to FIG. 4, illustrated is an example of a retransmission configuration for allocation of resources for selective retransmission, with a bundle size of four consecutive TBs. Prescheduling may be performed via DG for the repetitions. At 410, the network may transmit, to a UE, a DCI for prescheduling resource (s) for ReTX of bundle 1 (420), which may include transport blocks 1, 2, 3, and 4. The UE may transmit, to the network, a resource indication 430. At 440, the UE may repeat transmission of one or more TBs (e.g. TBx). The bundle size and the index of the repeated TB transmission (i.e., the value of x) may be signaled during RRC configuration, or using the DCI message at 410, or other radio signaling such as MAC Control Element (CE). At 450, the network may transmit, to the UE, a DCI for prescheduling ReTX of bundle 2 (460), which may include transport blocks 5, 6, 7, and 8. The UE may transmit, to the network, a resource indication 470. At 480, the UE may repeat transmission of one or more TBs according to the indication received by the network through RRC configuration or DCI message at 450. In the example of FIG. 4, where the transport block is successfully received, this is indicated with ‘S’ (TB1, TB2, TB5, TB7, TB8); where the transport block is lost/failure, this is indicated with ‘F’ (TB3, TB4, TB6).

In an example embodiment, pre-scheduled resource (s) for repetition may be configured via CG. The repetition may be configured over frequency resources. In a first option, if the original UL pose data is scheduled via a CG, the initial configuration of the CG may add one or more instances for the repeated PUSCH transmission (s) (i.e. retransmission (s)). In other words, the initial CG configuration may be different from other CG configurations in that it includes grant (s) for retransmission (s) of one or more packets. These added instances may be configured to happen after a bundle of ‘M’ UL pose PUSCH transmissions. The size of the bundle (which may be indicated via a new RRC parameter), M, may be configured by the network.

In a second option, a separate CG may be configured to carry the scheduling of the repeated transmissions. The periodicity of this CG may be M times the periodicity of the original pose data CG. The difference between these two options (single CG configuration vs separate CG configuration) is that with a separate configuration, the gNB may have more freedom to choose different CG parameters such as MCS for the repetition CG. For example, a more conservative MCS may be selected for a more important pose update. One use case may be the scenario where the repetitions are sent using more conservative MCS (e.g. more robust to error) than the original transmissions. For this case, a new parameter to show the linkage of these two CG configurations may be needed so that the UE will know that the same TB will be transmitted over the two CG resources. For example, CG0 may be configured to schedule transmission of original TBs, and CG1 may be configured to schedule retransmission/repetition of TBs in CG0. The gNB may indicate that CG0 and CG1 are related, and that the TBs scheduled for retransmission/repetition in CG1 are, in fact, a repetition of a subset of the TBs that were configured for original transmission in CG0.

In the present disclosure, the terms “retransmission,” “repetition,” and “repetition instance” may be used interchangeably to refer to a transmission that has already been made, but may not have been received at the network and so is being sent by the UE at least a second time.

In a third option, if the original pose data is scheduled via DG for the initial transmission, the repetition instances may still be scheduled via CG, where the configurations may or may not inherit some configurations (such as MCS) from the corresponding UL DG of the pose information. The CG may indicate, to the UE, whether any inheritance should occur and/or what inheritance should occur. The UE may interpret configuration(s) to be inherited after receipt of DG based, at least partially, on this indication in CG. Similar to the above options, the periodicity of the retransmission may be configured as a function of M consecutive DG-based PUSCH or any other periodicity configured by the gNB that may be considered the periodicity of the traffic, for example 5 ms for pose information. For example, the gNB may schedule repetition based on the periodicity information of the (initial) pose data.

Where CG is used according to an example embodiment of the present disclosure, an option for TTI bundling may be enabled for a determined subset of the CG resources.

In another example embodiment, pre-scheduled repetition may be configured via DG. In a first option, if the original UL pose data is scheduled via a CG, a DG-based pre-scheduling for the repetition may be done/provided. The gNB may send a scheduling DCI to notify the UE of the TB (s)/HARQ process (es) that should be repeated. Similar to the above options, discussions about the decision on the bundle size and MCS selection may also be valid for this example embodiment.

In a second option, if the original pose data is scheduled via DG, an additional DG-based pre-scheduling for the repetition may be done. MCS selection may or may not be inherited from the original pose data DG.

In an example embodiment, the number of repeated TBs may be reported in several ways.

For example, the number of TBs selected for repetition may be reported with a bit-map of size M, which may be transmitted/sent in a new field in the scheduling DCI to indicate which pose PUSCH transmission will be repeated. For example, for a bundle size of M=4 and configuring 2nd and the last PUSCH repetition, the bit-map may be, for example, 0101. The choice of TB may be dynamic, and may vary from bundle to bundle. Such information may be carried by the existing field in the DCI as well.

For example, the number of TBs selected for repetition may be reported with a direct indication, such as a vector of integers of size N in DCI or another message/signaling/indication, where N is the number of repeated TBs, and each element indicates the index of the TB. For the example mentioned above, the indication may be [10,100]. This solution may be favorable for N=1 (i.e. where only one PUSCH is repeated) and a single number is reported. The choice of TB may be dynamic, and may vary from bundle to bundle.

For example, the number of TBs selected for repetition may be reported with a fixed configuration, such as a fixed index that may be set as default for all the repetitions. Such indication may be done, for instance, using an RRC message. This option may be favorable if the bundle size M and number of repeated TBs N and their indices are fixed. An example of a recommendation may be to only repeat the last TB in the bundle, as it may be the most relevant, and recent data for the incoming XR DL traffic. The choice of TB may be fixed between/among bundles. Alternatively, the HARQ process number may be reported with a fixed configuration.

For example, the number of TBs selected for repetition may be reported with a formula. For example, the UE may update a counter C for each transmitted TB, and may repeat the TB for which the formula mod(C,M)=S holds true in the next scheduling opportunity. In the formula, M and S may be integer numbers signaled by the network, for example indicating the repetition cycle and which TB must be retransmitted/repeated according to a retransmission configuration.

A technical effect of having a dynamic index choice for repeated TB may be to enable compensation for periodicity drifts.

In an example embodiment, bundle size M may be configured as an arbitrary number. In another example embodiment, bundle size M may be selected based on traffic periodicities in UL (e.g. pose traffic with periodicity Tₚₒₛₑ) and DL (video traffic with periodicity T_{DL}). For example, the parameter choice due to the relationship between UL and DL traffic may be M=Ceil (Tₚₒₛₑ/T_{DL}), where Ceil stands for the ceiling function. For instance, for an XR video traffic in DL with 60 frames per second (fps) (T_{DL}≈16.67 ms) and UL pose period of 4 ms, then M=4. For example, the parameter choice may be an alternating M to compensate the periodicity drift. A technical effect of such a parameter may be to better match the non-integer properties of the exact ratio of the periodicities. For instance, for an XR video traffic in DL with 60 frames per second (fps) (T_{DL}≈16.67 ms) and UL pose period of 4 ms, the ratio of the periodicities is Tₚₒₛₑ/T_{DL}≈4.167, and an alternating pattern of M=4-4-4-5 may be used to compensate the non-integer part. To indicate this alternation, two approaches may be used. For example, in a semi-static approach, signaling may be performed via RRC, so that both gNB and UE follow a dynamic bundling, starting from the first UL pose PUSCH. This option may more favorable with pre-scheduling done via CG, where the configuration may be fixed for a longer period of time. For example, with a dynamic approach, a dynamic indication may be conveyed every time when a DCI is sent for the repetition data. This option may be more favorable with pre-scheduling done via DG, where configurations may be dynamically changing.

In an example embodiment, in a case where DG is used to schedule resource (s) for repetition, the UE may be configured such that the DG resource right after the CG resource (assuming CG is used for the initial transmission) is always used for the retransmission of the last TB carried by CG (i.e. no additional indication is needed in DCI). Alternatively, the gNB may use the HARQ process number in the DCI to inform the UE to retransmit the TB for the specific HARQ process. In an example embodiment, for the case of CG, (i.e. where there is no DCI), the gNB may set aside more (or double) frequency resources every M transmissions. In other words, the gNB may allocate frequency resources for retransmission with a periodicity of M. Alternatively, the gNB may set two CG configurations, and the decision to switch between the CG configurations may be made based on how the number of repeated TBs may be reported.

A technical effect of example embodiments of the present disclosure may be to increase the reliability of the transmission of critical pose updates.

In an example embodiment, a triggered configuration may be implemented and/or provided by a network to a UE. In an example embodiment, instead of having a fixed pre-scheduled repetition, the HARQ re-transmission may only be activated after N consecutive failures/loss, or N failures within a sliding time window. In other words, retransmission is not scheduled and/or performed unless N failures/losses have taken place; if less than N failures/losses have taken place, retransmission is not scheduled and/or performed. This method may be useful compared to the HARQ-less method, as it may have the technical effect of maintaining the reliability of a subset of important UL pose/haptic data traffic. If the pose data scheduling is carried using a CG, the retransmission grant may be a DG based resource.

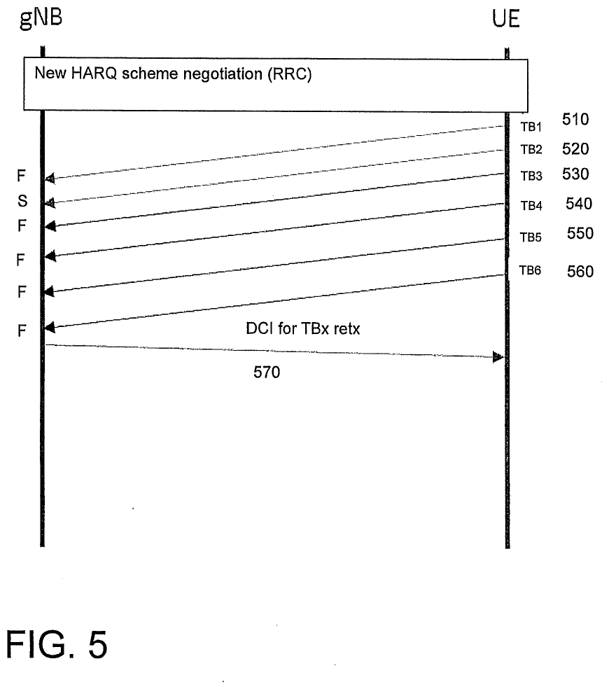

Referring now to FIG. 5, illustrated is an example of a triggered configuration for allocation of resources for selective retransmission, where a retransmission may be scheduled after N=4 consecutive TB fails (e.g. a predetermined number of failures). The UE may transmit, to the gNB, TB1 (510), TB2 (520), TB3 (530), TB4 (540), TB5 (550), and TB6 (560). After TB3 (530), TB4 (540), TB5 (550), and TB6 (560) fail, the gNB may transmit, to the UE, a DCI for one or multiple transport block (s) retransmission (570).

It may be noted that, although UL traffic has been taken as the example to describe the proposed selective HARQ retransmission schemes in the present disclosure, this is not limiting; the concept may be applied for DL as well, where for example HARQ-ACK feedback from the UE may not be needed for every DL PDSCH transmission.

In an example embodiment, the activation of the retransmission process may be conditional on a certain condition depending on the failed UL pose/haptic packets.

In an example embodiment, a parameter F, which may indicate the number of consecutive failed pose PUSCH transmissions or the number of failed pose PUSCH transmission within a sliding time window (window length can be configured beforehand), may be configured at the gNB to trigger a retransmission scheduling for one or more of the failed PUSCH instances. Indication of the index of requested repeating TBs may be in one of the following schemes: last TB, or the N latest TBs. In the last TB scheme, the retransmission may be scheduled only for the last failed TB. This option may be more favorable if the PDB is very small (<10 ms) and the retransmission of the previous failed TBs may not be useful, as their delay budget may have already expired. In the N latest TBs scheme, a set of TB indices may be indicated in the scheduling DCI to be retransmitted. This option may be more relevant if the PDB is more relaxed and failed pose data can still be recovered. In another example embodiment, each of the N TBs may be scheduled via a separate DCI, at the cost of more signaling overhead but less impact on current DCI formats.

In another example embodiment, a parameter R, which may indicate a ratio of failed pose PUSCH transmissions, and parameter W, which may indicate a moving window size to calculate R, may be configured at the gNB to trigger a retransmission scheduling for one or more of the failed PUSCH instances. In other words, scheduling of retransmission may be triggered where a ratio of lost TB to received TB within a time window is greater than a predetermined threshold value. Indication of the index of requested repeating TBs may be according to one of the options above.

A technical effect of example embodiments of the present disclosure may be to at least partially maintain the reliability of the pose information.

In an example embodiment, selective HARQ retransmission in one QoS flow may be performed while taking into account the relevant traffic flow.

In an example embodiment, a gNB and a UE may be enabled to determine the TBs to be retransmitted timely (i.e. with respect to the PDB) in a very flexible manner.

In an example embodiment, a retransmission configuration may allocate extra repeating resources to avoid losing of a subset of pose/haptic packets that are critical for the incoming DL video stream.

In an example embodiment, a triggered configuration may enable HARQ retransmission only if additional conditions are triggered (e.g. consecutive packet loses). A technical effect of example embodiments of the present disclosure may be to avoid wasting UL resources for expired packets, but also recovering some of the lost packets while it is possible.

In an example embodiment, retransmission may be performed only for selected TBs. TBs that are not selected may not be retransmitted.

In an example embodiment, the network may proactively signal the TB (s) that must be re-transmitted within the bundle.

A technical effect of example embodiments of the present disclosure may be to offer a selective retransmission solution that deals with the problem of later than packet delay budget retransmissions of delay-sensitive-short-lifetime packets such as XR pose and haptic data.

A technical effect of example embodiments of the present disclosure may be to eliminate the waiting time for ReTX scheduling DCI.

In an example embodiment, a first configuration for scheduling resources for retransmission/repetition may be triggered based on one or more conditions (e.g. number of losses/failures as described above). If the network is triggered to send the first configuration to the UE based on the one or more conditions, the first configuration may comprise a retransmission configuration for allocation of resources for selective retransmission, the network may thereafter proceed to periodically provide retransmission configuration (s) without triggering based on the one or more conditions. In an example embodiment, the network may monitor one or more deactivation triggers. For example, a deactivation trigger may be if N successful UL transmissions are performed/received, or are performed/received within a time window. If N successful UL transmissions are not yet detected, then the gNB may continue to provide retransmission configuration (s) periodically until such a deactivation trigger has been met/detected. When a deactivation trigger is detected, the network may stop periodically providing retransmission configuration (s) without triggering based on the one or more conditions, and switch to monitoring the one or more conditions again.

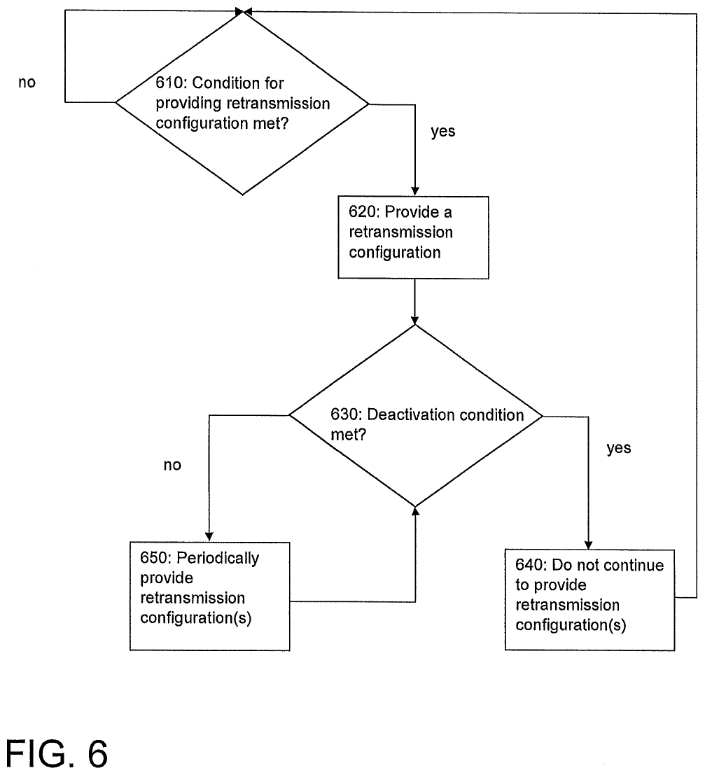

Referring now to FIG. 6, illustrated is a flowchart in which one or more conditions are initially monitored before a retransmission configuration is transmitted to the UE, after which retransmission configuration(s) may be periodically provided to the UE until a deactivation trigger is met. At 610, the network may determine whether one or more conditions for providing a retransmission configuration has been met. If no, the network may continue to monitor the one or more conditions. If yes, at 620 the network may provide a retransmission configuration to a UE. At 630, the network may determine whether one or more deactivation conditions have been met. If yes, at 640 the network may determine to no longer provide retransmission configuration(s) to the UE until one or more conditions for providing a retransmission configuration are met, 610. These conditions may be the same as or different from the conditions previously monitored. If the network determines that the one or more deactivation conditions have not been met, at 650 the network may periodically provide one or more retransmission configurations to the UE. The network may continue to provide the one or more retransmission configurations to the UE while continuing to monitor the one or more deactivation conditions.

It may be noted that example embodiments described in the present disclosure combined; a may be for example, repetition/retransmission configuration as illustrated in FIG. 5 may be triggered, after which time the network may periodically provide a further repetition/retransmission configuration as illustrated in FIG. 4 without triggering based on one or more conditions.

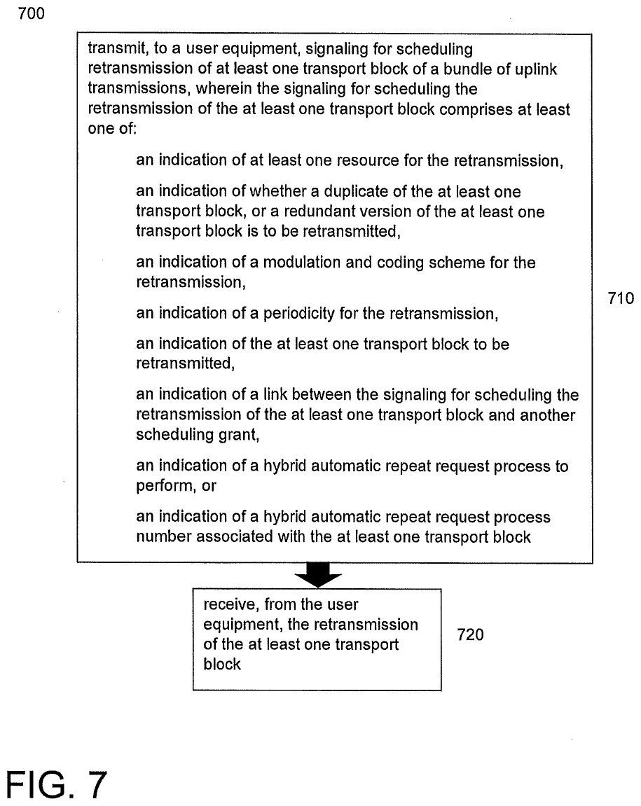

FIG. 7 illustrates the potential steps of an example method 700. The example method 700 may include: transmitting, to a user equipment, signaling for scheduling retransmission of at least one transport block of a bundle of uplink transmissions, wherein the signaling for scheduling the retransmission of the at least one transport block comprises at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block, 710; and receiving, from the user equipment, the retransmission of the at least one transport block, 720. The example method 700 may be performed, for example, with a network node, gNB, eNB, base station, etc.

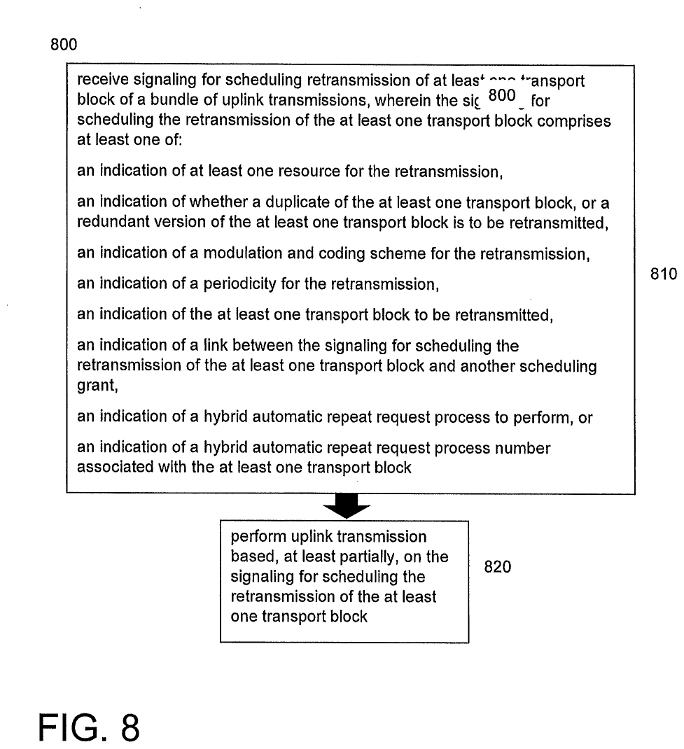

FIG. 8 illustrates the potential steps of an example method 800. The example method 800 may include: receiving signaling for scheduling retransmission of at least one transport block of a bundle of uplink transmissions, wherein the signaling for scheduling the retransmission of the at least one transport block comprises at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block, 810; and performing uplink transmission based, at least partially, on the signaling for scheduling the retransmission of the at least one transport block, 820. The example method 800 may be performed, for example, with a UE.

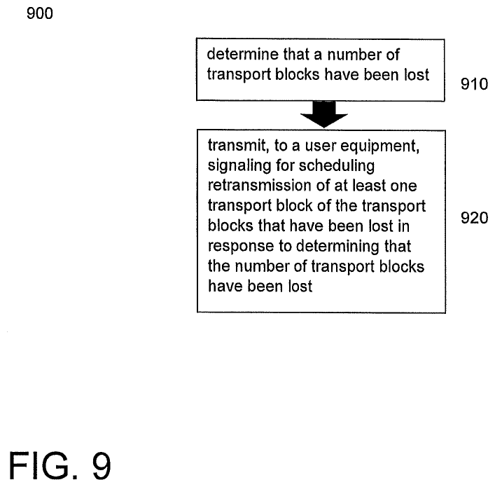

FIG. 9 illustrates the potential steps of an example method 900. The example method 900 may include: determining that a number of transport blocks have been lost, 910; and transmit, to a user equipment, signaling for scheduling retransmission of at least one transport block of the transport blocks that have been lost in response to determining that the number of transport blocks have been lost, 920. The example method 900 may be performed, for example, with a network node, gNB, eNB, base station, etc. It may be noted that the example method 900 may occur after or in conjunction with the example method 700.

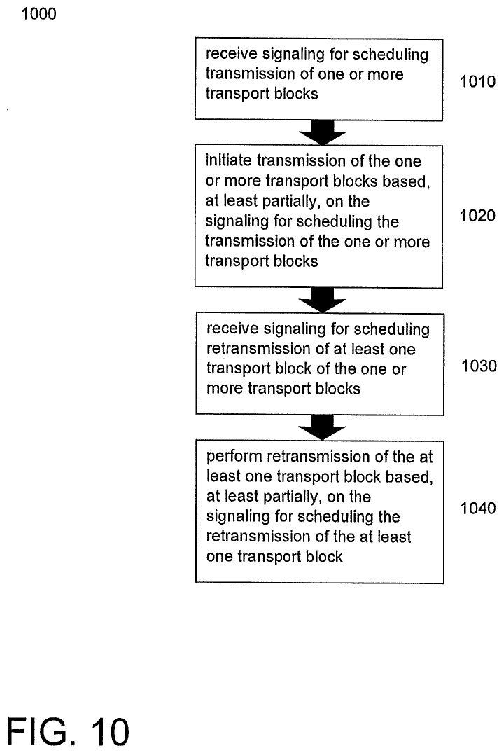

FIG. 10 illustrates the potential steps of an example method 1000. The example method 1000 may include: receiving signaling for scheduling transmission of one or more transport blocks, 1010; initiating transmission of the one or more transport blocks based, at least partially, on the signaling for scheduling the transmission of the one or more transport blocks, 1020; receiving signaling for scheduling retransmission of at least one transport block of the one or more transport blocks, 1030; and performing retransmission of the at least one transport block based, at least partially, on the signaling for scheduling the retransmission of the at least one transport block, 1040. The example method 1000 may be performed, for example, with a UE.

In accordance with one example embodiment, an apparatus may comprise: at least one processor; and at least one memory storing instructions that, when executed by the at least one processor, cause the apparatus at least to: transmit, to a user equipment, signaling for scheduling retransmission of at least one transport block of a bundle of uplink transmissions, wherein the signaling for scheduling the retransmission of the at least one transport block may comprise at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and receive, from the user equipment, the retransmission of the at least one transport block.

Transmitting the signaling for retransmission of the at least one transport block may be based, at least partially, on at least one of: a traffic periodicity the user equipment is using for initial transmission of one or more transport blocks, a bundle size of the bundle of uplink transmissions, or a respective priority of the at least one transport block.

The signaling for scheduling the retransmission of the at least one transport block may comprise at least one of: a configured grant, or a dynamic grant.

The signaling for scheduling the retransmission of the at least one transport block may comprise a configured grant, wherein signaling for scheduling initial transmission of one or more transport blocks may comprise a dynamic grant or a configured grant.

The signaling for scheduling the retransmission of the at least one transport block may comprise a dynamic grant, wherein signaling for scheduling initial transmission of one or more transport blocks may comprise a dynamic grant or a configured grant.

The at least one transport block may comprise a last transport block of the bundle of uplink transmissions or last N transport blocks of the bundle of uplink transmissions, wherein the N is larger than one.

The modulation and coding scheme for the retransmission of the at least one transport block may be at least one of: inherited from initial transmission of one or more transport blocks, or at least partially different from a modulation and coding scheme indicated for initial transmission of one or more transport blocks.

The example apparatus may be further configured to: transmit, to the user equipment, a radio resource control parameter configured to indicate a first number, wherein the retransmission of the at least one transport block may be configured to be scheduled after initial transmission of the first number of one or more transport blocks.

The signaling for scheduling the retransmission of the at least one transport block may comprise, at least, the indication of the at least one transport block to be retransmitted, wherein the indication of the at least one transport block to be retransmitted may comprise at least one of: a bit-map, an index of the at least one transport block, a set of indices, a number of last N transport block, wherein the N is larger than 1, a fixed configuration associated with the at least one transport block that is configured to be selected via a radio resource control message, or an indication of a formula for determining the at least one transport block.

The example apparatus may be further configured to: determine that a number of transport blocks have been lost; and transmit, to the user equipment, the signaling for scheduling retransmission of the at least one transport block in response to determining that the number of transport blocks have been lost.

Transmitting to the user equipment the signaling for scheduling retransmission may further include: determine that a number of transport blocks have been lost.

Determining that the number of the transport blocks have been lost may comprise the example apparatus being further configured to: determine that the number of transport blocks have been lost within a sliding time window.

Determining that the number of the transport blocks have been lost may comprise the example apparatus being further configured to: determine that a ratio of the transport blocks that have been lost to one or more transport blocks that have been received during a predetermined time window is greater than a predetermined threshold.

The signaling for scheduling the retransmission of the at least one transport block may be configured to schedule a last transport block, of the transport blocks that have been lost, for retransmission.

The signaling for scheduling the retransmission of the at least one transport block may be configured to schedule a set of indices, of the transport blocks that have been lost, for retransmission.

The signaling for scheduling the retransmission of the at least one transport block may comprise a plurality of signals that are respectively configured to schedule for retransmission a respective one of the transport blocks that have been lost.

The example apparatus may be further configured to: periodically transmit signaling for scheduling retransmission of one or more transport blocks without determining that a further number of transport blocks have been lost; monitor at least one deactivation condition; in response to determining that the at least one deactivation condition has been met, stop periodically transmitting signaling for scheduling the retransmission of the one or more transport blocks without determining that the further number of transport blocks have been lost; and monitor whether the further number of transport blocks have been lost.

In accordance with one aspect, an example method may be provided comprising: transmitting, to a user equipment, signaling for scheduling retransmission of at least one transport block of a bundle of uplink transmissions, wherein the signaling for scheduling the retransmission of the at least one transport block may comprise at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and receiving, from the user equipment, the retransmission of the at least one transport block.

The transmitting of the signaling for retransmission of the at least one transport block may be based, at least partially, on at least one of: a traffic periodicity the user equipment is using for initial transmission of one or more transport blocks, a bundle size of the bundle of uplink transmissions, or a respective priority of the at least one transport block.

The signaling for scheduling the retransmission of the at least one transport block may comprise at least one of: a configured grant, or a dynamic grant.

The signaling for scheduling the retransmission of the at least one transport block may comprise a configured grant, wherein signaling for scheduling initial transmission of one or more transport blocks may comprise a dynamic grant or a configured grant.

The signaling for scheduling the retransmission of the at least one transport block may comprise a dynamic grant, wherein signaling for scheduling initial transmission of one or more transport blocks may comprise a dynamic grant or a configured grant.

The at least one transport block may comprise a last transport block of the bundle of uplink transmissions or last N transport blocks of the bundle of uplink transmissions, wherein the N is larger than one.

The modulation and coding scheme for the retransmission of the at least one transport block may be at least one of: inherited from initial transmission of one or more transport blocks, or at least partially different from a modulation and coding scheme indicated for initial transmission of one or more transport blocks.

The example method may further comprise: transmitting, to the user equipment, a radio resource control parameter configured to indicate a first number, wherein the retransmission of the at least one transport block may be configured to be scheduled after initial transmission of the first number of one or more transport blocks.

The signaling for scheduling the retransmission of the at least one transport block may comprise, at least, the indication of the at least one transport block to be retransmitted, wherein the indication of the at least one transport block to be retransmitted may comprise at least one of: a bit-map, an index of the at least one transport block, a set of indices, a number of last N transport block, wherein the N is larger than 1, a fixed configuration associated with the at least one transport block that is configured to be selected via a radio resource control message, or an indication of a formula for determining the at least one transport block.

The example method may further comprise: determining that a number of transport blocks have been lost; and transmitting, to the user equipment, the signaling for scheduling retransmission of the at least one transport block in response to determining that the number of transport blocks have been lost.

The transmitting to the user equipment of the signaling for scheduling retransmission may further include: determining that a number of transport blocks have been lost.

The determining that the number of the transport blocks have been lost may comprise: determining that the number of transport blocks have been lost within a sliding time window.

The determining that the number of the transport blocks have been lost may comprise: determining that a ratio of the transport blocks that have been lost to one or more transport blocks that have been received during a predetermined time window is greater than a predetermined threshold.

The signaling for scheduling the retransmission of the at least one transport block may be configured to schedule a last transport block, of the transport blocks that have been lost, for retransmission.

The signaling for scheduling the retransmission of the at least one transport block may be configured to schedule a set of indices, of the transport blocks that have been lost, for retransmission.

The signaling for scheduling the retransmission of the at least one transport block may comprise a plurality of signals that are respectively configured to schedule for retransmission a respective one of the transport blocks that have been lost.

The example method may further comprise: periodically transmitting signaling for scheduling retransmission of one or more transport blocks without determining that a further number of transport blocks have been lost; monitoring at least one deactivation condition; in response to determining that the at least one deactivation condition has been met, stopping periodically transmitting signaling for scheduling the retransmission of the one or more transport blocks without determining that the further number of transport blocks have been lost; and monitoring whether the further number of transport blocks have been lost.

In accordance with one example embodiment, an apparatus may comprise: circuitry configured to perform: transmitting, to a user equipment, signaling for scheduling retransmission of at least one transport block of a bundle of uplink transmissions, wherein the signaling for scheduling the retransmission of the at least one transport block may comprise at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and circuitry configured to perform: receiving, from the user equipment, the retransmission of the at least one transport block.

In accordance with one example embodiment, an apparatus may comprise: processing circuitry; memory circuitry including computer program code, the memory circuitry and the computer program code configured to, with the processing circuitry, enable the apparatus to: transmit, to a user equipment, signaling for scheduling retransmission of at least one transport block of a bundle of uplink transmissions, wherein the signaling for scheduling the retransmission of the at least one transport block may comprise at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and receive, from the user equipment, the retransmission of the at least one transport block.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), a such as microprocessor(s) or a portion of a microprocessor (s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for performing: transmitting, to a user equipment, signaling for scheduling retransmission of at least one transport block of a bundle of uplink transmissions, wherein the signaling for scheduling the retransmission of the at least one transport block may comprise at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and receiving, from the user equipment, the retransmission of the at least one transport block.

A processor, memory, and/or example algorithms (which may be encoded as instructions, program, or code) may be provided as example means for providing or causing performance of operation.

In accordance with one example embodiment, a non-transitory computer-readable medium comprising instructions stored thereon which, when executed with at least one processor, cause the at least one processor to: cause transmitting, to a user equipment, of signaling for scheduling retransmission of at least one transport block of a bundle of uplink transmissions, wherein the signaling for scheduling the retransmission of the at least one transport block may comprise at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and cause receiving, from the user equipment, of the retransmission of the at least one transport block.

In accordance with one example embodiment, a non-transitory computer-readable medium comprising program instructions stored thereon for performing at least the following: causing transmitting, to a user equipment, of signaling for scheduling retransmission of at least one transport block of a bundle of uplink transmissions, wherein the signaling for scheduling the retransmission of the at least one transport block may comprise at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and causing receiving, from the user equipment, of the retransmission of the at least one transport block.

In accordance with another example embodiment, a non-transitory program storage device readable by a machine may be provided, tangibly embodying instructions executable by the machine for performing operations, the operations comprising: causing transmitting, to a user equipment, of signaling for scheduling retransmission of at least one transport block of a bundle of uplink transmissions, wherein the signaling for scheduling the retransmission of the at least one transport block may comprise at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and causing receiving, from the user equipment, of the retransmission of the at least one transport block.

In accordance with another example embodiment, a non-transitory computer-readable medium comprising instructions that, when executed by an apparatus, cause the apparatus to perform at least the following: causing transmitting, to a user equipment, of signaling for scheduling retransmission of at least one transport block of a bundle of uplink transmissions, wherein the signaling for scheduling the retransmission of the at least one transport block may comprise at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and causing receiving, from the user equipment, of the retransmission of the at least one transport block.

A computer implemented system comprising: at least one processor and at least one non-transitory memory storing instructions that, when executed by the at least one processor, cause the system at least to perform: causing transmitting, to a user equipment, of signaling for scheduling retransmission of at least one transport block of a bundle of uplink transmissions, wherein the signaling for scheduling the retransmission of the at least one transport block may comprise at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and causing receiving, from the user equipment, of the retransmission of the at least one transport block.

A computer implemented system comprising: means for causing transmitting, to a user equipment, of signaling for scheduling retransmission of at least one transport block of a bundle of uplink transmissions, wherein the signaling for scheduling the retransmission of the at least one transport block may comprise at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and means for causing receiving, from the user equipment, of the retransmission of the at least one transport block.

In accordance with one example embodiment, an apparatus may comprise: at least one processor; and at least one memory storing instructions that, when executed by the at least one processor, cause the apparatus at least to: receive signaling for scheduling retransmission of at least one transport block of a bundle of uplink transmissions, wherein the signaling for scheduling the retransmission of the at least one transport block may comprise at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and perform uplink transmission based, at least partially, on the signaling for scheduling the retransmission of the at least one transport block.

The signaling for scheduling the retransmission of the at least one transport block may comprise at least one of: a configured grant, or a dynamic grant.

The signaling for scheduling the retransmission of the at least one transport block may comprise a configured grant, wherein signaling for scheduling initial transmission of one or more transport blocks may comprise a dynamic grant or a configured grant.

The signaling for scheduling the retransmission of the at least one transport block may comprise a dynamic grant, wherein signaling for scheduling initial transmission of one or more transport blocks may comprise a dynamic grant or a configured grant.

The at least one transport block may comprise a last transport block of the bundle of uplink transmissions or last N transport blocks of the bundle of uplink transmissions, wherein the N is larger than one.

The modulation and coding scheme for the retransmission of the at least one transport block may be at least one of: inherited from initial transmission of one or more transport blocks, or at least partially different from a modulation and coding scheme indicated for initial transmission of one or more transport blocks.

The example apparatus may be further configured to: receive a radio resource control parameter configured to indicate a first number, wherein the retransmission of the at least one transport block may be configured to be scheduled after initial transmission of the first number of one or more transport blocks.

The signaling for scheduling the retransmission of the at least one transport block may comprise, at least, the indication of the at least one transport block to be retransmitted, wherein the indication of the at least one transport block to be retransmitted may comprise at least one of: a bit-map, an index of the at least one transport block, a set of indices, a number of last N transport block, wherein the N is larger than 1, a fixed configuration associated with the at least one transport block that is configured to be selected via a radio resource control message, or an indication of a formula for determining the at least one transport block.

In accordance with one aspect, an example method may be provided comprising: receiving, with a user equipment, signaling for scheduling retransmission of at least one transport block of a bundle of uplink transmissions, wherein the signaling for scheduling the retransmission of the at least one transport block may comprise at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and performing uplink transmission, with the user equipment, based, at least partially, on the signaling for scheduling the retransmission of the at least one transport block.

The signaling for scheduling the retransmission of the at least one transport block may comprise at least one of: a configured grant, or a dynamic grant.

The signaling for scheduling the retransmission of the at least one transport block may comprise a configured grant, wherein signaling for scheduling initial transmission of one or more transport blocks may comprise a dynamic grant or a configured grant.

The signaling for scheduling the retransmission of the at least one transport block may comprise a dynamic grant, wherein signaling for scheduling initial transmission of one or more transport blocks may comprise a dynamic grant or a configured grant.

The at least one transport block may comprise a last transport block of the bundle of uplink transmissions or last N transport blocks of the bundle of uplink transmissions, wherein the N is larger than one.

The modulation and coding scheme for the retransmission of the at least one transport block may be at least one of: inherited from initial transmission of one or more transport blocks, or at least partially different from a modulation and coding scheme indicated for initial transmission of one or more transport blocks.

The example method may further comprise: receiving a radio resource control parameter configured to indicate a first number, wherein the retransmission of the at least one transport block may be configured to be scheduled after initial transmission of the first number of one or more transport blocks.

The signaling for scheduling the retransmission of the at least one transport block may comprise, at least, the indication of the at least one transport block to be retransmitted, wherein the indication of the at least one transport block to be retransmitted may comprise at least one of: a bit-map, an index of the at least one transport block, a set of indices, a number of last N transport block, wherein the N is larger than 1, a fixed configuration associated with the at least one transport block that is configured to be selected via a radio resource control message, or an indication of a formula for determining the at least one transport block.

In accordance with one example embodiment, an apparatus may comprise: circuitry configured to perform: receiving, with a user equipment, signaling for scheduling retransmission of at least one transport block of a bundle of uplink transmissions, wherein the signaling for scheduling the retransmission of the at least one transport block may comprise at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and circuitry configured to perform: performing uplink transmission, with the user equipment, based, at least partially, on the signaling for scheduling the retransmission of the at least one transport block.

In accordance with one example embodiment, an apparatus may comprise: processing circuitry; memory circuitry including computer program code, the memory circuitry and the computer program code configured to, with the processing circuitry, enable the apparatus to: receive signaling for scheduling retransmission of at least one transport block of a bundle of uplink transmissions, wherein the signaling for scheduling the retransmission of the at least one transport block may comprise at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and perform uplink transmission based, at least partially, on the signaling for scheduling the retransmission of the at least one transport block.

In accordance with one example embodiment, an apparatus may comprise means for performing: receiving signaling for scheduling retransmission of at least one transport block of a bundle of uplink transmissions, signaling for scheduling the retransmission of the at least one transport block may comprise at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and uplink transmission based, at least partially, signaling for scheduling the retransmission of the at least one transport block.

In accordance with one example embodiment, a non-transitory computer-readable medium comprising instructions stored thereon which, when executed with at least one processor, cause the at least one processor to: cause receiving of signaling for scheduling retransmission of at least one transport block of a bundle of uplink transmissions, wherein the signaling for scheduling the retransmission of the at least one transport block may comprise at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and cause performing of uplink transmission based, at least partially, on the signaling for scheduling the retransmission of the at least one transport block.

In accordance with one example embodiment, a non-transitory computer-readable medium comprising program instructions stored thereon for performing at least the following: causing receiving of signaling for scheduling retransmission of at least one transport block of a bundle of uplink transmissions, wherein the signaling for scheduling the retransmission of the at least one transport block may comprise at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and causing performing of uplink transmission based, at least partially, on the signaling for scheduling the retransmission of the at least one transport block.

In accordance with another example embodiment, a non-transitory program storage device readable by a machine may be provided, tangibly embodying instructions executable by the machine for performing operations, the operations comprising: causing receiving of signaling for scheduling retransmission of at least one transport block of a bundle of uplink transmissions, wherein the signaling for scheduling the retransmission of the at least one transport block may comprise at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and causing performing of uplink transmission based, at least partially, on the signaling for scheduling the retransmission of the at least one transport block.

In accordance with another example embodiment, a non-transitory computer-readable medium comprising instructions that, when executed by an apparatus, cause the apparatus to perform at least the following: causing receiving of signaling for scheduling retransmission of at least one transport block of a bundle of uplink transmissions, wherein the signaling for scheduling the retransmission of the at least one transport block may comprise at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and causing performing of uplink transmission based, at least partially, on the signaling for scheduling the retransmission of the at least one transport block.

A computer implemented system comprising: at least one processor and at least one non-transitory memory storing instructions that, when executed by the at least one processor, cause the system at least to perform: causing receiving of signaling for scheduling retransmission of at least one transport block of a bundle of uplink transmissions, wherein the signaling for scheduling the retransmission of the at least one transport block may comprise at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and causing performing of uplink transmission based, at least partially, on the signaling for scheduling the retransmission of the at least one transport block.

A computer implemented system comprising: means for causing receiving of signaling for scheduling retransmission of at least one transport block of a bundle of uplink transmissions, wherein the signaling for scheduling the retransmission of the at least one transport block may comprise at least one of: an indication of at least one resource for the retransmission, an indication of whether a duplicate of the at least one transport block, or a redundant version of the at least one transport block is to be retransmitted, an indication of a modulation and coding scheme for the retransmission, an indication of a periodicity for the retransmission, an indication of the at least one transport block to be retransmitted, an indication of a link between the signaling for scheduling the retransmission of the at least one transport block and another scheduling grant, an indication of a hybrid automatic repeat request process to perform, or an indication of a hybrid automatic repeat request process number associated with the at least one transport block; and means for causing performing of uplink transmission based, at least partially, on the signaling for scheduling the retransmission of the at least one transport block.

In accordance with one example embodiment, an apparatus may comprise: at least one processor; and at least one memory storing instructions that, when executed by the at least one processor, cause the apparatus at least to: determine that a number of transport blocks have been lost; and transmit, to a user equipment, signaling for scheduling retransmission of at least one transport block of the transport blocks that have been lost in response to determining that the number of transport blocks have been lost.

The signaling for scheduling the retransmission of the at least one transport block may comprise at least one of: a configured grant, or a dynamic grant.

Determining that the number of the transport blocks have been lost may comprise the example apparatus being further configured to: determine that the number of transport blocks have been lost within a sliding time window.

Determining that the number of the transport blocks have been lost may comprise the example apparatus being further configured to: determine that a ratio of the transport blocks that have been lost to one or more transport blocks that have been received during a predetermined time window is greater than a predetermined threshold.

The signaling for scheduling the retransmission of the at least one transport block may be configured to schedule a last transport block, of the transport blocks that have been lost, for retransmission.

The signaling for scheduling the retransmission of the at least one transport block may be configured to schedule a set of indices, of the transport blocks that have been lost, for retransmission.

The signaling for scheduling the retransmission of the at least one transport block may comprise a plurality of signals that are respectively configured to schedule for retransmission a respective one of the transport blocks that have been lost.

Transmitting the signaling for retransmission of the at least one transport block may be based, at least partially, on at least one of: a traffic periodicity the user equipment is using for transmission of one or more transport blocks, a bundle size associated with the at least one transport block, or a respective priority of the at least one transport block.

The example apparatus may be further configured to: periodically transmit signaling for scheduling retransmission of one or more transport blocks without determining that a further number of transport blocks have been lost; monitor at least one deactivation condition; in response to determining that the at least one deactivation condition has been met, stop periodically transmitting signaling for scheduling the retransmission of the one or more transport blocks without determining that the further number of transport blocks have been lost; and monitor whether the further number of transport blocks have been lost.

In accordance with one aspect, an example method may be provided comprising: determining that a number of transport blocks have been lost; and transmitting, to a user equipment, signaling for scheduling retransmission of at least one transport block of the transport blocks that have been lost in response to determining that the number of transport blocks have been lost.

The signaling for scheduling the retransmission of the at least one transport block may comprise at least one of: a configured grant, or a dynamic grant.

The determining that the number of the transport blocks have been lost may comprise: determining that the number of transport blocks have been lost within a sliding time window.

The determining that the number of the transport blocks have been lost may comprise: determining that a ratio of the transport blocks that have been lost to one or more transport blocks that have been received during a predetermined time window is greater than a predetermined threshold.

The signaling for scheduling the retransmission of the at least one transport block may be configured to schedule a last transport block, of the transport blocks that have been lost, for retransmission.

The signaling for scheduling the retransmission of the at least one transport block may be configured to schedule a set of indices, of the transport blocks that have been lost, for retransmission.

The signaling for scheduling the retransmission of the at least one transport block may comprise a plurality of signals that are respectively configured to schedule for retransmission a respective one of the transport blocks that have been lost.

The transmitting of the signaling for retransmission of the at least one transport block may be based, at least partially, on at least one of: a traffic periodicity the user equipment is using for transmission of one or more transport blocks, a bundle size associated with the at least one transport block, or a respective priority of the at least one transport block.

The example method may further comprise: periodically transmitting signaling for scheduling retransmission of one or more transport blocks without determining that a further number of transport blocks have been lost; monitoring at least one deactivation condition; in response to determining that the at least one deactivation condition has been met, stopping periodically transmitting signaling for scheduling the retransmission of the one or more transport blocks without determining that the further number of transport blocks have been lost; and monitoring whether the further number of transport blocks have been lost.

In accordance with one example embodiment, an apparatus may comprise: circuitry configured to perform: determining that a number of transport blocks have been lost; and circuitry configured to perform: transmitting, to a user equipment, signaling for scheduling retransmission of at least one transport block of the transport blocks that have been lost in response to determining that the number of transport blocks have been lost.

In accordance with one example embodiment, an apparatus may comprise: processing circuitry; memory circuitry including computer program code, the memory circuitry and the computer program code configured to, with the processing circuitry, enable the apparatus to: determine that a number of transport blocks have been lost; and transmit, to a user equipment, signaling for scheduling retransmission of at least one transport block of the transport blocks that have been lost in response to determining that the number of transport blocks have been lost.

In accordance with one example embodiment, an apparatus may comprise means for performing: determining that a number of transport blocks have been lost; and transmitting, to a user equipment, signaling for scheduling retransmission of at least one transport block of the transport blocks that have been lost in response to determining that the number of transport blocks have been lost.

In accordance with one example embodiment, a non-transitory computer-readable medium comprising instructions stored thereon which, when executed with at least one processor, cause the at least one processor to: determine that a number of transport blocks have been lost; and cause transmitting, to a user equipment, of signaling for scheduling retransmission of at least one transport block of the transport blocks that have been lost in response to determining that the number of transport blocks have been lost.

In accordance with one example embodiment, a non-transitory computer-readable medium comprising program instructions stored thereon for performing at least the following: determining that a number of transport blocks have been lost; and causing transmitting, to a user equipment, of signaling for scheduling retransmission of at least one transport block of the transport blocks that have been lost in response to determining that the number of transport blocks have been lost.

In accordance with another example embodiment, a non-transitory program storage device readable by a machine may be provided, tangibly embodying instructions executable by the machine for performing operations, the operations comprising: determining that a number of transport blocks have been lost; and causing transmitting, to a user equipment, of signaling for scheduling retransmission of at least one transport block of the transport blocks that have been lost in response to determining that the number of transport blocks have been lost.

In accordance with another example embodiment, a non-transitory computer-readable medium comprising instructions that, when executed by an apparatus, cause the apparatus to perform at least the following: determining that a number of transport blocks have been lost; and causing transmitting, to a user equipment, of signaling for scheduling retransmission of at least one transport block of the transport blocks that have been lost in response to determining that the number of transport blocks have been lost.

A computer implemented system comprising: at least one processor and at least one non-transitory memory storing instructions that, when executed by the at least one processor, cause the system at least to perform: determining that a number of transport blocks have been lost; and causing transmitting, to a user equipment, of signaling for scheduling retransmission of at least one transport block of the transport blocks that have been lost in response to determining that the number of transport blocks have been lost.

A computer implemented system comprising: means for determining that a number of transport blocks have been lost; and means for causing transmitting, to a user equipment, of signaling for scheduling retransmission of at least one transport block of the transport blocks that have been lost in response to determining that the number of transport blocks have been lost.

In accordance with one example embodiment, an apparatus may comprise: at least one processor; and at least one memory storing instructions that, when executed by the at least one processor, cause the apparatus at least to: receive signaling for scheduling transmission of one or more transport blocks; initiate transmission of the one or more transport blocks based, at least partially, on the signaling for scheduling the transmission of the one or more transport blocks; receive signaling for scheduling retransmission of at least one transport block of the one or more transport blocks; and perform retransmission of the at least one transport block based, at least partially, on the signaling for scheduling the retransmission of the at least one transport block.

The signaling for scheduling the transmission of the one or more transport blocks may comprise at least one of: a configured grant, or a dynamic grant.

The signaling for scheduling the retransmission of the at least one transport block may be configured to schedule a last transport block for retransmission.

The signaling for scheduling the retransmission of the at least one transport block may be configured to schedule a set of transport block indices for retransmission.

The signaling for scheduling the retransmission of the at least one transport block may comprise signals that are respectively configured to schedule for retransmission a respective transport block.

In accordance with one aspect, an example method may be provided comprising: receiving, with a user equipment, signaling for scheduling transmission of one or more transport blocks; initiating transmission of the one or more transport blocks based, at least partially, on the signaling for scheduling the transmission of the one or more transport blocks; receiving signaling for scheduling retransmission of at least one transport block of the one or more transport blocks; and performing retransmission of the at least one transport block based, at least partially, on the signaling for scheduling the retransmission of the at least one transport block.

The signaling for scheduling the transmission of the one or more transport blocks may comprise at least one of: a configured grant, or a dynamic grant.

The signaling for scheduling the retransmission of the at least one transport block may be configured to schedule a last transport block for retransmission.

The signaling for scheduling the retransmission of the at least one transport block may be configured to schedule a set of transport block indices for retransmission.

The signaling for scheduling the retransmission of the at least one transport block may comprise signals that are respectively configured to schedule for retransmission a respective transport block.

In accordance with one example embodiment, an apparatus may comprise: circuitry configured to perform: receiving, with a user equipment, signaling for scheduling transmission of one or more transport blocks; circuitry configured to perform: initiating transmission of the one or more transport blocks based, at least partially, on the signaling for scheduling the transmission of the one or more transport blocks; circuitry configured to perform: receiving signaling for scheduling retransmission of at least one transport block of the one or more transport blocks; and circuitry configured to perform: performing retransmission of the at least one transport block based, at least partially, on the signaling for scheduling the retransmission of the at least one transport block.

In accordance with one example embodiment, an apparatus may comprise: processing circuitry; memory circuitry including computer program code, the memory circuitry and the computer program code configured to, with the processing circuitry, enable the apparatus to: receive signaling for scheduling transmission of one or more transport blocks; initiate transmission of the one or more transport blocks based, at least partially, on the signaling for scheduling the transmission of the one or more transport blocks; receive signaling for scheduling retransmission of at least one transport block of the one or more transport blocks; and perform retransmission of the at least one transport block based, at least partially, on the signaling for scheduling the retransmission of the at least one transport block.

In accordance with one example embodiment, an apparatus may comprise means for performing: receiving signaling for scheduling transmission of one or more transport blocks; initiating transmission of the one or more transport blocks based, at least partially, on the signaling for scheduling the transmission of the one or more transport blocks; receiving signaling for scheduling retransmission of at least one transport block of the one or more transport blocks; and retransmission of the at least one transport block based, at least partially, on the signaling for scheduling the retransmission of the at least one transport block.

In accordance with one example embodiment, a non-transitory computer-readable medium comprising instructions stored thereon which, when executed with at least one processor, cause the at least one processor to: cause receiving of signaling for scheduling transmission of one or more transport blocks; initiate transmission of the one or more transport blocks based, at least partially, on the signaling for scheduling the transmission of the one or more transport blocks; cause receiving of signaling for scheduling retransmission of at least one transport block of the one or more transport blocks; and cause performing of retransmission of the at least one transport block based, at least partially, on the signaling for scheduling the retransmission of the at least one transport block.

In accordance with one example embodiment, a non-transitory computer-readable medium comprising program instructions stored thereon for performing at least the following: causing receiving of signaling for scheduling transmission of one or more transport blocks; initiating transmission of the one or more transport blocks based, at least partially, on the signaling for scheduling the transmission of the one or more transport blocks; causing receiving of signaling for scheduling retransmission of at least one transport block of the one or more transport blocks; and causing performing of retransmission of the at least one transport block based, at least partially, on the signaling for scheduling the retransmission of the at least one transport block.

In accordance with another example embodiment, a non-transitory program storage device readable by a machine may be provided, tangibly embodying instructions executable by the machine for performing operations, the operations comprising: causing receiving of signaling for scheduling transmission of one or more transport blocks; initiating transmission of the one or more transport blocks based, at least partially, on the signaling for scheduling the transmission of the one or more transport blocks; causing receiving for of signaling scheduling retransmission of at least one transport block of the one or more transport blocks; and causing performing of retransmission of the at least one transport block based, at least partially, on the signaling for scheduling the retransmission of the at least one transport block.

In accordance with another example embodiment, a non-transitory computer-readable medium comprising instructions that, when executed by an apparatus, cause the apparatus to perform at least the following: causing receiving of signaling for scheduling transmission of one or more transport blocks; initiating transmission of the one or more transport blocks based, at least partially, on the signaling for scheduling the transmission of the one or more transport blocks; causing receiving of signaling for scheduling retransmission of at least one transport block of the one or more transport blocks; and causing performing of retransmission of the at least one transport block based, at least partially, on the signaling for scheduling the retransmission of the at least one transport block.

A computer implemented system comprising: at least one processor and at least one non-transitory memory storing instructions that, when executed by the at least one processor, cause the system at least to perform: causing receiving of signaling for scheduling transmission of one or more transport blocks; initiating transmission of the one or more transport blocks based, at least partially, on the signaling for scheduling the transmission of the one or more transport blocks; causing receiving of signaling for scheduling retransmission of at least one transport block of the one or more transport blocks; and causing performing of retransmission of the at least one transport block based, at least partially, on the signaling for scheduling the retransmission of the at least one transport block.

A computer implemented system comprising: means for causing receiving of signaling for scheduling transmission of one or more transport blocks; means for initiating transmission of the one or more transport blocks based, at least partially, on the signaling for scheduling the transmission of the one or more transport blocks; means for causing receiving of signaling for scheduling retransmission of at least one transport block of the one or more transport blocks; and means for causing performing of retransmission of the at least one transport block based, at least partially, on the signaling for scheduling the retransmission of the at least one transport block.

The term “non-transitory,” as used herein, is a limitation of the medium itself (i.e. tangible, not a signal) as opposed to a limitation on data storage persistency (e.g., RAM vs. ROM).

It should be understood that the foregoing description is only illustrative. Various alternatives and modifications can be devised by those skilled in the art. For example, features recited in the various dependent claims could be combined with each other in any suitable combination (s). In addition, features from different embodiments described above could be selectively combined into a new embodiment. Accordingly, the description is intended to embrace all such alternatives, modification and variances which fall within the scope of the appended claims.

1. An apparatus, comprising:
at least one processor; and
at least one non-transitory memory storing instructions that, when executed with the at least one processor, cause the apparatus at least to:
transmit, to a user equipment, signaling for scheduling retransmission of at least one transport block of a bundle of uplink transmissions, wherein the signaling for scheduling the retransmission of the at least one transport block comprises at least one of:
an indication of at least one resource for the retransmission,
an indication of whether a duplicate of the at least one transport block, or a redundant version of the at least one transport block is to be retransmitted,
an indication of a modulation and coding scheme for the retransmission,
an indication of a periodicity for the retransmission,
an indication of the at least one transport block to be retransmitted,
an indication of a link between the signaling for scheduling the retransmission of the at least one transport block and another scheduling grant,
an indication of a hybrid automatic repeat request process to perform, or
an indication of a hybrid automatic repeat request process number associated with the at least one transport block; and
receive, from the user equipment, the retransmission of the at least one transport block.

2. The apparatus of claim 1, wherein transmitting the signaling for retransmission of the at least one transport block is based, at least partially, on at least one of:
a traffic periodicity the user equipment is using for initial transmission of one or more transport blocks,
a bundle size of the bundle of uplink transmissions, or
a respective priority of the at least one transport block.

3. The apparatus of claim 1, wherein the signaling for scheduling the retransmission of the at least one transport block comprises at least one of:
a configured grant, or
a dynamic grant.

4. The apparatus of claim 1, wherein the signaling for scheduling the retransmission of the at least one transport block comprises a configured grant, wherein signaling for scheduling initial transmission of one or more transport blocks comprises a dynamic grant or a configured grant.

5. The apparatus of claim 1, wherein the signaling for scheduling the retransmission of the at least one transport block comprises a dynamic grant, wherein signaling for scheduling initial transmission of one or more transport blocks comprises a dynamic grant or a configured grant.

6. The apparatus of claim 1, wherein the at least one transport block comprises a last transport block of the bundle of uplink transmissions or last N transport blocks of the bundle of uplink transmissions, wherein the N is larger than one.

7. The apparatus of claim 1, wherein the modulation and coding scheme for the retransmission of the at least one transport block is at least one of:
inherited from initial transmission of one or more transport blocks, or
at least partially different from a modulation and coding scheme indicated for initial transmission of one or more transport blocks.

8-28. (canceled)

29. An apparatus, comprising:
at least one processor; and
at least one non-transitory memory storing instructions that, when executed with the at least one processor, cause the apparatus at least to:
receive signaling for scheduling retransmission of at least one transport block of a bundle of uplink transmissions, wherein the signaling for scheduling the retransmission of the at least one transport block comprises at least one of:
an indication of at least one resource for the retransmission,
an indication of whether a duplicate of the at least one transport block, or a redundant version of the at least one transport block is to be retransmitted,
an indication of a modulation and coding scheme for the retransmission,
an indication of a periodicity for the retransmission,
an indication of the at least one transport block to be retransmitted,
an indication of a link between the signaling for scheduling the retransmission of the at least one transport block and another scheduling grant,
an indication of a hybrid automatic repeat request process to perform, or
an indication of a hybrid automatic repeat request process number associated with the at least one transport block; and
perform uplink transmission based, at least partially, on the signaling for scheduling the retransmission of the at least one transport block.

30. The apparatus of claim 29, wherein the signaling for scheduling the retransmission of the at least one transport block comprises at least one of:
a configured grant, or
a dynamic grant.

31. The apparatus of claim 29, wherein the signaling for scheduling the retransmission of the at least one transport block comprises a configured grant, wherein signaling for scheduling initial transmission of one or more transport blocks comprises a dynamic grant or a configured grant.

32. The apparatus of claim 29, wherein the signaling for scheduling the retransmission of the at least one transport block comprises a dynamic grant, wherein signaling for scheduling initial transmission of one or more transport blocks comprises a dynamic grant or a configured grant.

33. The apparatus of claim 29, wherein the at least one transport block comprises a last transport block of the bundle of uplink transmissions or last N transport blocks of the bundle of uplink transmissions, wherein the N is larger than one.

34. The apparatus of claim 29, wherein the modulation and coding scheme for the retransmission of the at least one transport block is at least one of:
inherited from initial transmission of one or more transport blocks, or
at least partially different from a modulation and coding scheme indicated for initial transmission of one or more transport blocks.

35. The apparatus of claim 29, wherein the instructions, when executed with the at least one processor, cause the apparatus to:
receive a radio resource control parameter configured to indicate a first number, wherein the retransmission of the at least one transport block is configured to be scheduled after initial transmission of the first number of one or more transport blocks.

36. The apparatus of claim 29, wherein the signaling for scheduling the retransmission of the at least one transport block comprises, at least, the indication of the at least one transport block to be retransmitted, wherein the indication of the at least one transport block to be retransmitted comprises at least one of:
a bit-map,
an index of the at least one transport block,
a set of indices,
a number of last N transport block, wherein the N is larger than 1,
a fixed configuration associated with the at least one transport block that is configured to be selected via a radio resource control message, or
an indication of a formula for determining the at least one transport block.

37-66. (canceled)

67. An apparatus, comprising:
at least one processor; and
at least one non-transitory memory storing instructions that, when executed with the at least one processor, cause the apparatus at least to:
receive signaling for scheduling transmission of one or more transport blocks;
initiate transmission of the one or more transport blocks based, at least partially, on the signaling for scheduling the transmission of the one or more transport blocks;
receive signaling for scheduling retransmission of at least one transport block of the one or more transport blocks; and
perform retransmission of the at least one transport block based, at least partially, on the signaling for scheduling the retransmission of the at least one transport block.

68. The apparatus of claim 67, wherein the signaling for scheduling the transmission of the one or more transport blocks comprises at least one of:
a configured grant, or
a dynamic grant.

69. The apparatus of claim 67, wherein the instructions, when executed with the at least one processor, schedule a last transport block for retransmission.

70. The apparatus of claim 67, wherein the instructions, when executed with the at least one processor, schedule a set of transport block indices for retransmission.

71. The apparatus of claim 67, wherein the signaling for scheduling the retransmission of the at least one transport block comprises signals that are respectively configured to schedule for retransmission a respective transport block.

72-78. (canceled)
